(19) United States
(12) Patent Application Publication
(10) Pub. No.: US 2005/0105838 A1
(43) Pub. Date: May 19, 2005

(54) Bearing with compressible rolling elements

(75) Inventor: Michael C. Brauer, New Hartford, CT (US)

Correspondence Address: MICHAEL BEST & FRIEDRICH LLP, 3773 CORPORATE PARKWAY, SUITE 360, CENTER VALLEY, PA, 18034-8217, US

(73) Assignee: Timken US Corporation, Torrington, CT (US)

(21) Appl. No.: 10/714,997

(22) Filed: Nov. 17, 2003

(51) Int. Cl. F16C 33/62; F16C 33/32

(52) U.S. Cl. 384/492

(57) ABSTRACT

A rolling element bearing comprising opposed inner and outer raceways positionable in a loaded position. A plurality of substantially rigid load bearing rolling elements are positioned between and in generally point contact with the inner and outer raceways when the raceways are in the loaded position. A plurality of compressible rolling elements are positioned between the inner and outer raceways and have surface area contact with the inner and outer raceways when the raceways are in the loaded position.

### BACKGROUND

The present invention relates to an improved bearing assembly having primary, though not exclusive use, as a bearing assembly for steering columns for use in automotive vehicles.

A steering column includes all the elements necessary to enable motions of a steering wheel to be transmitted to a steering rack. The steering column includes a housing in which a shaft, linking together the steering wheel and the steering rack, is guided in rotation. The shaft is supported in the housing by a plurality of bearing assemblies.

When used in steering columns, bearing assemblies must satisfy a number of conditions. Vehicle manufacturers specify the mounting, speed and temperature conditions at which the bearing assemblies will need to operate. The bearing assemblies must allow stresses from the steering wheel to be transmitted via the shaft and must run silently. The bearing assemblies are often utilized to dampen small movements or “noises” transmitted through the shaft from the driving terrain.

While steering columns are designed to freely rotate, they are typically provided with a parasitic torque to dampen rotational displacements and to provide the user with a tactile feel. One prior art attempt to accomplish such has been an increase in the preload on the steering column bearings, however, the increased preload often causes more rapid bearing wear. Other prior steering column bearings have utilized contact type wiper or seal lips, however, the contact material requires an additional part and does not provide accurate torque control. Heavy grease has also been provided in steering column bearings to provide parasitic torque, however, the effects of the grease vary greatly with the temperature.

### SUMMARY

The present invention relates to a housed rotational shaft assembly comprising a shaft, a housing enclosing at least a portion of the shaft, and a bearing mounted within the housing and supporting the shaft. The bearing comprises opposed inner and outer raceways positionable in a loaded position. A plurality of substantially rigid load bearing rolling elements are positioned between the inner and outer raceways when the raceways are in the loaded position. A plurality of compressible rolling elements are positioned between the inner and outer raceways and have surface area contact, greater than point or line contact, with the inner and outer raceways when the raceways are in the loaded position. The loaded position may be from internal preload or from externally applied load.

### BRIEF DESCRIPTION OF THE DRAWINGS

FIG. 1 is a cross sectional view of a housed steering column incorporating a first embodiment of the present invention;

FIG. 2 is a cross sectional view of a housed steering column incorporating a second embodiment of the present invention;

FIG. 2 is a cross sectional view of a housed steering column incorporating a third embodiment of the present invention;

FIG. 4 is a cutaway pictorial view of the ball bearing of FIG. 1 showing half the bearing removed;

FIG. 5 is a drawing of bearing raceways and load bearing and compressible rolling elements without significant load thereupon;

FIG. 6 is a drawing of the bearing according to FIG. 5 under load or in a preloaded condition; and

FIG. 7 is a drawing of an alternate embodiment of the bearing of the present invention.

### DETAILED DESCRIPTION OF THE PREFERRED EMBODIMENTS

The present invention will be described with reference to the accompanying drawing figures wherein like numbers represent like elements throughout. Certain terminology, for example, “top”, “bottom”, “right”, “left”, “front”, “frontward”, “forward”, “back”, “rear” and “rearward”, is used in the following description for relative descriptive clarity only and is not intended to be limiting.

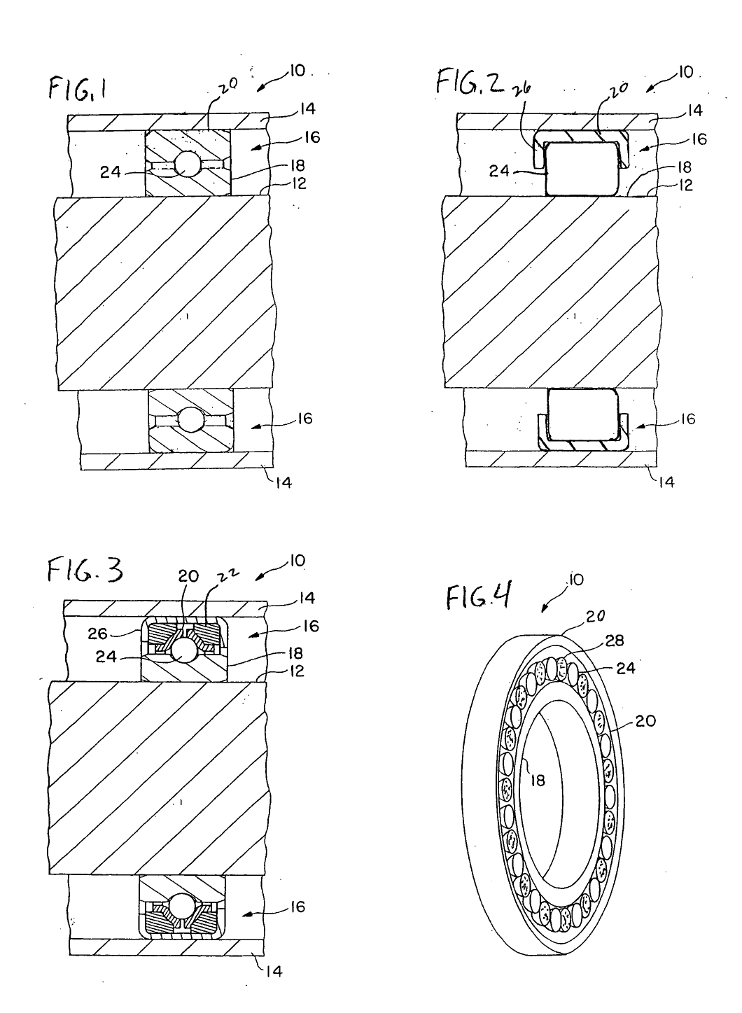

Referring now to the drawings, FIGS. 1-3 illustrate a housed steering column 10 according to various embodiments of the present invention. In each embodiment, the steering column 10 comprises a steering shaft 12, a housing 14 enclosing at least a portion of the steering shaft 12, and a roller bearing 16 positioned therebetween. While the present invention is described in conjunction with a steering shaft 12, the invention may be used with other rotatable assemblies.

The roller bearing 16 of each embodiment generally includes inner and outer races 18, 20 with a plurality of load bearing rolling elements 24 and compressible rolling elements 28. The various embodiments show different configurations of these elements. These embodiments are shown for illustrative purposes and the invention is not limited to these specific embodiments.

Referring to FIG. 1, the ball bearing 16 of the first embodiment includes machined inner and outer races 18 and 20. The illustrated embodiments has the inner race 18 press fit upon the shaft 20 and the outer race 20 press fit within the housing 14, but both may be otherwise configured. The rolling elements 24 and 28 of the first embodiment are round bearing balls. Referring to FIG. 2, the bearing 16 has a drawn cup 26 as the outer race 20. The inner race 18 is provided by the shaft 12. Alternatively, the drawn cup 26 may be provided as the inner race 18, with the housing 14 serving as the outer race 20. The rolling elements 24 and 28 of the second embodiment are cylindrical needle rollers. Referring to FIG. 3, the bearing 16 has a machined inner race 18 and a two-piece outer race 20 that provides two angular contact raceways that are loaded by resilient biasing members 22 against load bearing balls 24 and the compressible balls 28. A drawn cup 26 encloses the resilient biasing members 22, compressing them together, and is press fit into the housing 14. The machined inner race 18 is press fit over the steering shaft 12. Again, the various embodiments illustrate that the inner and outer races 18, 20 and the rolling elements 24, 28 can have various configurations without departing from the spirit and scope of the present invention.

As shown in FIG. 4, in each embodiment, the compressible rolling elements 28 (indicated by stippled shading) are located in the angular contact raceway provided by the inner and outer races 18 and 20, with one compressible rolling element 28 being positioned between each load bearing rolling element 24. Referring to FIG. 5, the compressible rolling elements 28 are preferably slightly larger, i.e., having a diameter larger than that of the load bearing rolling elements 24. The compressible rolling elements 28 are preferably a few thousandths to ten thousandths of an inch larger in diameter than the load bearing rolling elements 24, preferably 5-15 percent larger than the load bearing rolling elements 24. The compressible rolling elements 28 are manufactured from a deformable material, preferably a material having elastomeric qualities, i.e. a material that deforms under a given load and substantially returns to its original form when the load is removed, but does not have to be elastomeric. The material may be natural material, e.g. natural rubber, or synthetic material, e.g. urethane rubber.

Referring to FIG. 6, the compressible rolling element 28 material is deformable such that when a load is applied on one of the bearing races 18, 20, either due to a preload or an external load, the rolling elements 28 deform such that the rolling elements 28 have a surface contact area 40 against the races 18, 20 greater than a point contact or line contact. In contradistinction, the load bearing rolling elements 24 are made from a rigid material, for example, steel, that does not yield to the applied load, but instead bears the load, with the rolling elements 24 generally maintaining point contact (ball rolling elements) or line contact (needle roller rolling elements), with the races 18, 20. The rolling elements 24 are preferably commercially available rolling elements of carbon or chrome steel (defined by ABMA standard 10). The compressible rolling elements 28 also, may, but not necessarily, deform against the load bearing rolling elements 24 such that the rolling elements 28 have surface contact areas 42 against adjacent load bearing rolling elements 24 greater than point or line contact.

The increased contact surface area at the race contact areas 40 and the rolling element contact areas 42 cause rotational and spinning friction between the compressible rolling elements 28 and the races 18, 20, thereby creating a desired torque in the bearing 16. The size, surface finish and material properties of the compressible rolling elements 28 can be varied to provide different resultant torque under different operating conditions. The compression of the compressible rolling elements 28 also allows the bearing 16 to provide dampening of noise or vibration in the steering assembly. Depending on the requirements of the application, the compressible rolling element 28 size and material is chosen to provide the desired balance between torque generation and dampening.

Referring to FIG. 5, the bearing 16 is preferably assembled with minimal preload, such that the compressible rolling elements 28 support the minimal load, with the load bearing rolling elements 24 between the races 18 and 20. The rolling element bearing 16 is positioned in the housing 14 in this condition and is thereafter loaded by the shaft 12 to the loaded condition shown in FIG. 6. In the loaded condition, the compressible rolling elements 28 deform to provide the desired drag and resulting torque and or dampening. By providing the rolling element bearing 16 with minimal preload, the elasticity of the preferred compressible rolling elements 28 is allowed to compensate for shaft misalignments, component tolerances, and other discrepancies, thereby providing greater flexibility in the assembly. However, it is also contemplated that the rolling element bearing 16 may be preloaded to the condition shown in FIG. 6, i.e. having little or zero tolerance with the compressible rolling elements 28 already deformed. The elasticity of the preferred compressible bearings 28 also serves to absorb the “noise” transmitted through the shaft 12.

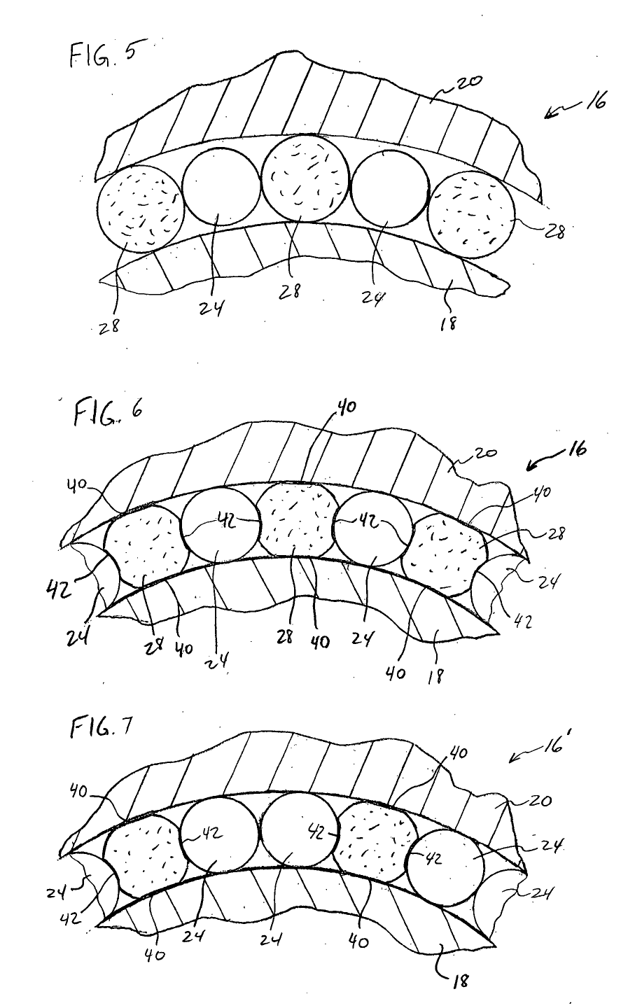

While it is preferred that the load bearing rolling elements 24 and compressible rolling elements 28 alternate, other configurations may also be utilized. FIG. 7 illustrates a rolling element bearing 16′ that is an alternative embodiment of the present invention. Rolling element bearing 16′ is substantially the same as in the previous embodiments, however, one compressible rolling element 28 is provided between each pair of load bearing rolling elements 24. Other arrangements may also be utilized.

1. A housed rotating shaft assembly comprising:
a shaft;
a housing enclosing at least a portion of the shaft; and
a rolling element bearing mounted within the housing and supporting the shaft, the rolling element bearing comprising:
opposed inner and outer raceways positionable in a loaded position;
a plurality of substantially rigid load bearing rolling elements positioned between and in generally point or line contact with the inner and outer raceways when the raceways are in the loaded position; and
a plurality of compressible rolling elements positioned between the inner and outer raceways and having surface area contact, greater than point and line contact, with the inner and outer raceways when the raceways are in the loaded position.

2. The housed rotating shaft assembly according to claim 1 wherein the load bearing rolling elements are smaller in diameter than the compressible rolling elements.

3. The housed rotating shaft assembly according to claim 1 wherein the compressible rolling elements are elastomeric.

4. The housed rotating shaft assembly according to claim 1 wherein the compressible rolling elements are made of an elastomeric material and the load bearing rolling elements are made of steel.

5. The housed rotating shaft assembly according to claim 1 wherein the rolling element bearing is mounted within the housing such that the opposed inner and outer raceways are initially positioned in the loaded position.

6. The housed rotating shaft assembly according to claim 1 wherein the rolling element bearing is mounted within the housing such that the opposed inner and outer raceways are initially positioned in a substantially unloaded position wherein the compressible rolling elements are generally free from deformation.

7. The housed rotating shaft assembly according to claim 1 wherein the load bearing rolling elements and the compressible rolling elements are positioned between the raceways in a 1 to 1 alternating relationship.

8. The housed rotating shaft assembly according to claim 1 wherein the load bearing rolling elements and the compressible rolling elements are positioned between the raceways in a 2 to 1, respectively, alternating relationship.

9. The housed rotating shaft assembly according to claim 1 wherein the shaft is part of a steering column.

10. The housed rotating shaft assembly according to claim 1 wherein the inner raceway is defined by the shaft.

11. The housed rotating shaft assembly according to claim 1 wherein the outer raceway is defined by the housing.

12. The housed rotating shaft assembly according to claim 1 wherein the rolling elements are balls.

13. The housed rotating shaft assembly according to claim 1 wherein the rolling elements are needle rollers.

14. A rolling element bearing configured for mounting within a housing for supporting a rotatable shaft, the rolling element bearing comprising:
opposed inner and outer raceways positionable in a loaded position;
a plurality of substantially rigid load bearing rolling elements positioned between and in generally point or line contact with the inner and outer raceways when the raceways are in the loaded position; and
a plurality of compressible rolling elements positioned between the inner and outer raceways and having surface area contact, greater than point and line contact, with the inner and outer raceways when the raceways are in the loaded position.

15. The rolling element bearing according to claim 14 wherein the load bearing rolling elements are smaller in diameter than the compressible rolling elements.

16. The rolling element bearing according to claim 14 wherein the compressible rolling elements are elastomeric.

17. The rolling element bearing according to claim 14 wherein the compressible rolling elements are made of an elastomeric material and the load bearing rolling elements are made of steel.

18. The rolling element bearing according to claim 14 wherein the rolling element bearing is mounted within the housing such that the opposed inner and outer raceways are initially positioned in the loaded position.

19. The rolling element bearing according to claim 14 wherein the rolling element bearing is mounted within the housing such that the opposed inner and outer raceways are initially positioned in a substantially unloaded position wherein the compressible rolling elements are not deformed.

20. The rolling element bearing according to claim 14 wherein the load bearing rolling elements and the compressible rolling elements are positioned between the raceways in a 1 to 1 alternating relationship.

21. The rolling element bearing according to'claim 14 wherein the load bearing rolling elements and the compressible rolling elements are positioned between the raceways in a 2 to 1, respectively, alternating relationship.

22. The rolling element bearing according to claim 14 wherein the rolling elements are balls.

23. The rolling element bearing assembly according to claim 14 wherein the rolling elements are needle rollers.
